(19) United States
(12) Patent Application Publication
(10) Pub. No.: US 2026/0158675 A1
(43) Pub. Date: Jun. 11, 2026

(54) Systems and Methods for Time-of-Flight Touch Sensors in Robots

(71) Applicant: Sanctuary Cognitive Systems Corporation, Vancouver (CA)

(72) Inventor: Alejandro Hernandez Herdocia, North Vancouver (CA)

(21) Appl. No.: 19/413,710

(22) Filed: Dec. 9, 2025

Related U.S. Application Data
(60) Provisional application No. 63/729,665, filed on Dec. 9, 2024.

(51) Int. Cl. B25J 13/08; B25J 9/00; B25J 19/00

(52) U.S. Cl. CPC B25J 13/084; B25J 9/0009; B25J 19/0025

(57) ABSTRACT

Provided are systems and methods for a touch sensor system for a robot end effector using a time-of-fight (TOF) system. A robot end effector includes a digit, and a tactile sensor system coupled to the digit. The tactile sensor system includes a set of fiber optic cables carried by the digit, wherein each fiber optic cable has a respective length and a first end of each fiber optic cable is at a distal end of the digit. A TOF sensor is coupled to a second end of each fiber optic cable, wherein the TOF sensor emits light through the set of fiber optic cables and receives light reflected by an object at or proximate the distal end of the digit through the set of fiber optic cables. A distance to the at least one object is calculated from a TOF path including the length(s) of the cable(s).

### TECHNICAL FIELD

The present systems and methods generally relate to robotics and particularly relate to tactile sensing by a robotic end effector.

### DESCRIPTION OF THE RELATED ART

Robots are machines that are configured to sense their environment and may be deployed to perform work autonomously or semi-autonomously. Robots may come in a variety of different form factors, including humanoid form factors wherein the robot has an appearance resembling a human. Robots perform their work using end effectors. A humanoid robot may have an end effector resembling, at least in part, a human hand.

For a robot to perform dexterous work within an environment, the robotic end effector(s) must be able to employ a sense of touch. Time-of-flight technology is often used to determine distances to objects. However, time-of-flight sensors cannot work at very short ranges because the speed of light exceeds the ability of the electronics to process time-of-flight signals over short distances. Thus, when an end effector needs to get very close to or touch an object, a conventional time-of-flight sensor cannot measure the small distance. There is a need in the field for improved systems and methods which are capable of integrating touch sensing into robotic end effectors.

### BRIEF SUMMARY

Provided herein is a robot end effector including a digit, and a tactile sensor system coupled to the digit, the tactile sensor system comprising a set of fiber optic cables carried by the digit, the set of fiber optic cables including at least one fiber optic cable, wherein each fiber optic cable has a respective length and wherein a first end of each fiber optic cable is at a distal end of the digit, and a time-of-flight (TOF) sensor coupled to a second end of each fiber optic cable, wherein the TOF sensor emits light through at least a first subset of the set of fiber optic cables, and receives light reflected by at least one object at or proximate the distal end of the digit through at least a second subset of the set of fiber optic cables, wherein a distance to the at least one object is calculable from a TOF path including the length.

The TOF sensor may include a single optical source. The TOF sensor may include a single optical detector. The TOF sensor may include a plurality of optical detectors.

Each optical detector of the plurality of optical detectors may be coupled to a respective fiber optic cable of the second subset of the set of fiber optic cables.

The robot end effector may further include a polarizer to polarize the emitted light.

The set of fiber optic cables may comprise a single fiber optic cable, wherein the first subset of fiber optic cables and the second subset of fibre optic cables are both the single fiber optic cable. The single fiber optic cable may include optical filters to enable emission and reflection in the single fiber optic cable.

The first subset of the set of fiber optic cables may comprise a first fiber optic cable which transmits emitted light from the TOF sensor and the second subset of the set of fiber optic cables may comprise a second fiber optic cable which transmits reflected light back to the TOF sensor.

The first subset of the set of fiber optic cables may include a plurality of fiber optic cables which transmit emitted light from the TOF sensor and the second subset of the set of fiber optic cables may include a plurality of fiber optic cables which transmit reflected light back to the TOF sensor.

The set of fiber optic cables may be arranged in a grid.

The first subset of the set of fiber optic cables may include only one fiber optic cable which transmits emitted light from the TOF sensor and the second subset of the set of fiber optic cables may include a plurality of fiber optic cables which transmit reflected light back to the TOF sensor.

The second subset of the set of fiber optic cables may be arranged in a grid.

The at least one object may be an object external to the end effector.

The at least one object may be a compliant covering on the digit, wherein the light is reflected from an inner surface of the compliant covering, and wherein the inner surface of the compliant covering is depressed when the digit touches an external object.

The compliant covering may comprise a plurality of internal volumes wherein at least one fiber optic cable of the set of fiber optic cables is directed into each respective internal volume of the plurality of internal volumes.

The length may be at least 10 mm.

The robot end effector may further comprise a second digit with a second tactile sensor system coupled to the second digit.

The tactile sensor system may be coupled to the at least a second digit, wherein the tactile sensor system further comprises at least a second set of fiber optic cables, wherein each additional digit is coupled to a respective set of fiber optic cables of the at least a second set of fiber optic cables.

The robot end effector of claim 1 wherein the digit is actuatable around at least one pivot point, wherein the set of fiber optic cables pass through the at least one pivot point and accommodate bending at the at least one pivot point.

Provided herein is a method of calculating a distance of a robot end effector to an object using a time-of-flight (TOF) system, the method including emitting a light signal from at least one emitter of a time-of-flight (TOF) sensor, wherein the light signal passes out of a distal end of a digit of the robot end effector through a set of fiber optic cables housed within the digit, receiving reflected light by at least one detector of the TOF sensor through the set of fiber optic cables, wherein the reflected light is light from the light signal which reflects off of at least one object in the environment of the end effector, and calculating a distance from the distal end of the digit to an object as (ct/2)-L, wherein c is the speed of light, t is the time for the emitted light to return to the TOF sensor, and L is the length of a fiber optic cable.

The light signal may be a pulse.

The light signal may comprise a narrow wavelength band.

The TOF sensor may include multiple emitters, and the multiple emitters may emit light of different wavelengths.

The set of fiber optic cables may include a single fiber optic cable which both emits and receives light.

The set of fiber optic cables may include a single fiber optic cable for emitting light and multiple fiber optic cables for receiving light.

The set of fiber optic cables may include multiple fiber optic cables for emitting light and multiple fiber optic cables for receiving light.

Each fiber optic cable which receives and transmits reflected light, may transmit the reflected light to one single detector.

Each fiber optic cable which receives and transmits reflected light, may transmit the reflected light to a respective detector.

Subsets of the fiber optic cables which receive and transmit reflected light, may transmit the reflected light to the same detector.

The at least one object may be an object external to the end effector.

The at least one object may be a compliant covering on the digit, wherein the light is reflected from an inner surface of the compliant covering, and wherein the inner surface of the compliant covering is depressed when the digit touches an external object.

The compliant covering may comprise a plurality of internal volumes wherein at least one fiber optic cable of the set of fiber optic cables is directed into each respective internal volume of the plurality of internal volumes.

Other aspects and features will become apparent to those ordinarily skilled in the art, upon review of the following description of some exemplary embodiments.

### BRIEF DESCRIPTION OF THE DRAWINGS

The various elements and acts depicted in the drawings are provided for illustrative purposes to support the detailed description. Unless the specific context requires otherwise, the sizes, shapes, and relative positions of the illustrated elements and acts are not necessarily shown to scale and are not necessarily intended to convey any information or limitation. In general, identical reference numbers are used to identify similar elements or acts.

FIG. 1 is a block diagram of a robot end effector time-of-flight (TOF) system with a single fiber optic cable, according to an embodiment.

FIG. 2 is a block diagram of a robot end effector time-of-flight (TOF) system with multiple fiber optic cables, according to an embodiment.

FIG. 3A is a block diagram of a robot end effector time-of-flight (TOF) system with a distal internal volume, wherein the robot end effector is not touching an object, according to an embodiment.

FIG. 3A is a block diagram of a robot end effector time-of-flight (TOF) system with a distal internal volume, wherein the robot end effector is touching an object, according to an embodiment.

FIG. 4A is a block diagram of a robot end effector time-of-flight (TOF) system, with multiple distal internal volumes and a single compliant covering, according to an embodiment.

FIG. 4B is a block diagram of a robot end effector time-of-flight (TOF) system, with multiple distal internal volumes each with a respective compliant covering, according to an embodiment.

FIG. 5 is a block diagram of a robot end effector time-of-flight (TOF) system wherein a TOF sensor is external to the end effector, according to an embodiment.

FIG. 6A is a schematic diagram of a robot end effector resembling a human hand and a first possible location for a TOF sensor within the hand, according to an embodiment.

FIG. 6B is a schematic diagram of a robot end effector resembling a human hand and a second possible location for a TOF sensor within the hand, according to an embodiment.

FIG. 6C is a schematic diagram of a robot end effector resembling a human hand and a third possible location for a TOF sensor within the hand, according to an embodiment.

FIG. 6D is a schematic diagram of a robot end effector resembling a human hand and a fourth possible location for a TOF sensor within the hand, according to an embodiment.

FIG. 6E is schematic diagram of a tip of a digit of a robot end effector which resembles a human hand, wherein the tip includes an internal volume and a compliant covering, according to an embodiment.

FIG. 6F is schematic diagram of a tip of a digit of a robot end effector which resembles a human hand, wherein the tip includes multiple internal volumes with respective compliant coverings, according to an embodiment.

FIG. 6G is a schematic diagram of a digit of the robot end effector of FIG. 6A in an extended position, according to an embodiment.

FIG. 6H is a schematic diagram of the digit of FIG. 5B in a flexed position, according to an embodiment.

FIG. 7 is a flow diagram of a method of calculating a distance to an object using a TOF system, according to an embodiment.

### DETAILED DESCRIPTION

The following description sets forth specific details in order to illustrate and provide an understanding of the various implementations and embodiments of the present systems, computer program products, and methods. A person of skill in the art will appreciate that some of the specific details described herein may be omitted or modified in alternative implementations and embodiments, and that the various implementations and embodiments described herein may be combined with each other and/or with other methods, components, materials, etc. in order to produce further implementations and embodiments.

In some instances, well-known structures and/or processes associated with computer systems and data processing have not been shown or provided in detail in order to avoid unnecessarily complicating or obscuring the descriptions of the implementations and embodiments.

Unless the specific context requires otherwise, throughout this specification and the appended claims the term “comprise” and variations thereof, such as “comprises” and “comprising,” are used in an open, inclusive sense to mean “including, but not limited to.”

Unless the specific context requires otherwise, throughout this specification and the appended claims the singular forms “a,” “an,” and “the” include plural referents. For example, reference to “an embodiment” and “the embodiment” include “embodiments” and “the embodiments,” respectively, and reference to “an implementation” and “the implementation” include “implementations” and “the implementations,” respectively. Similarly, the term “or” is generally employed in its broadest sense to mean “and/or” unless the specific context clearly dictates otherwise.

The headings and Abstract of the Disclosure are provided for convenience only and are not intended, and should not be construed, to interpret the scope or meaning of the present robots, computer program products, and methods.

As discussed above, robots employ end effectors to perform work within an environment by interacting with and touching objects within the environment. An end effector may also be referred to as an “end-of-arm” tool or, in some implementations, a “hand”. End effectors can perform simple tasks such as pushing, pulling, and lifting, or may perform more complex tasks, such as grabbing or manipulating.

Herein, a “hand” or “digits” are discussed as end effectors of the robot, however, it is to be understood that the end effector may take on other forms (e.g., a push bar, a hook, a suction cup, a gripper).

When an end effector is performing work, it is essential that the robot be able to sense a distance between an object and an end effector(s) and/or for sensing contact between an object and an end effector, i.e., “touch sensing” or “tactile sensing”. For touch/tactile sensing, the end effector may comprise an internal volume with a compliant covering which deforms when in contact with an object wherein the deformation can be used to sense if and how the end effector is contacting the object.

One example of a system of touch/tactile sensing is found in U.S. Pat. No. 11,867,574, which describes a fluidic tactile sensor, wherein a change in fluid pressure within a deformable cell of an end effector is sensed to measure contact with an object. While touch sensing can be performed using this change in fluid pressure, the parameters of the environment in which the robot exists can affect the functioning and calculations of the system. For example, using the system at different altitudes or in space may not be effective.

Time-of-flight (TOF) sensing is a general mechanism for measuring a distance by measuring the time an emitted light signal takes to travel to and reflect back from an object. A TOF sensor includes an emitter of light and a detector or receiver of light. The light signal leaves the emitter at t=0 and is reflected back from the object to the detector at t=t₁, wherein the distance between the sensor and the object is calculated as d=ct₁/2 (where c is the speed of light). However, TOF sensors have an operational range of 10-500 mm, as, at small distances, the speed of light is too fast for the sensor to process the very short period of time between the light being emitted from the sensor and the sensor detecting the reflected light. Therefore, known systems and methods of TOF sensing are not suitable for touch sensing (or very close proximity sensing) which necessitates measuring very small distances (e.g.1-2 mm).

The systems and method herein provide a TOF mechanism for end effector touch sensing using fiber optic cables to extend the length of the path between the TOF sensor and a distal end of the end effector.

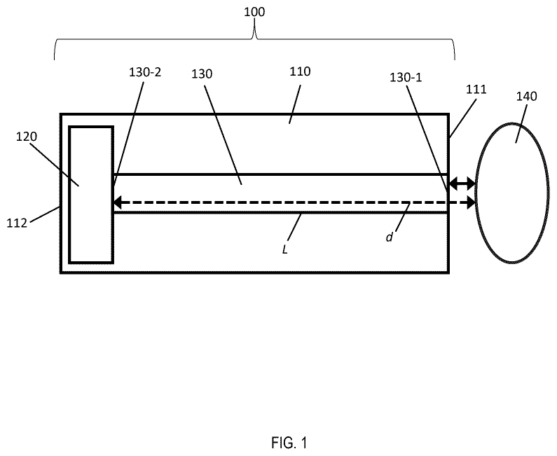

FIG. 1 is a block diagram of a robot end effector time-of-flight (TOF) system 100 with a single fiber optic cable, according to an embodiment. Elements of FIGS. 1-4 are not to scale.

The TOF system 100 comprises a robotic digit 110, a TOF sensor 120, and a fiber optic cable 130. The TOF system 100 is part of a robot which exists within an environment.

In some embodiments, the digit 110 may comprise a robotic finger that resembles a finger of a human hand. However, the use of the term “digit” is not meant to limit the form factor of the end effector to that of a humanoid finger. In other embodiments, the digit may resemble, for example, a hook or a rod which contacts an object.

As well, the inclusion of a single digit in FIGS. 1-4 is not meant to limit form factor of the end effector to a single digit. In other embodiments, the end effector may include multiple digits and the digits may differ in appearance and/or function.

Digit 110 has a distal end 111 and a proximal end 112, defined relative to an arm of the robot (not shown) to which the digit 110 is connected.

The TOF sensor 120 includes at least one optical source configured to emit a light signal into fiber optic cable 130 and at least one optical detector configured to receive a reflected light signal back from fiber optic cable 130.

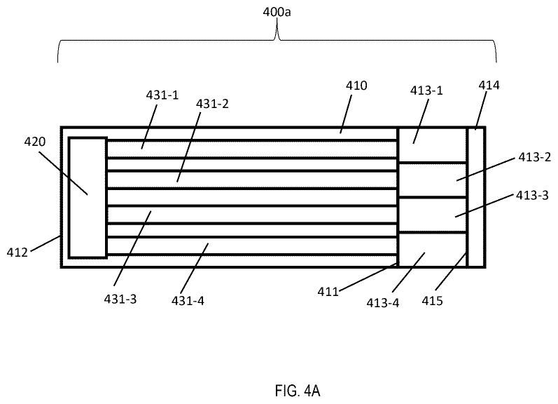

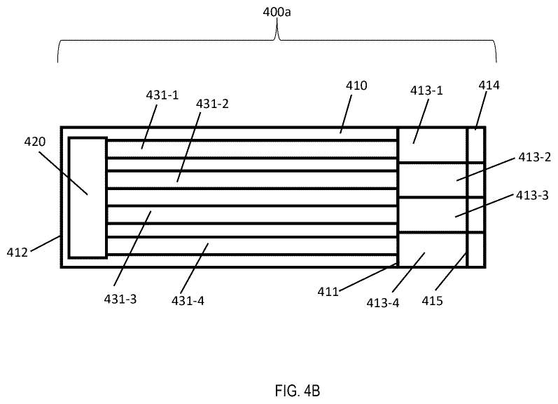

In FIG. 1, the TOF sensor 120 is located within the digit 110, however in other embodiments (see FIG. 4 below) the TOF sensor may be positioned externally to the digit 110 while still being operably connected to the digit 110 and the fiber optic cable 130.

A first end 130-1 of the fiber optic cable 130 is positioned at the distal end 111 and a second end 130-2 of the fiber optic cable 130 is positioned at the TOF sensor 120. Light is emitted from the optical source into the fiber optic cable 130 and out of the first end 130-1 into the environment of the robot. Light reflected back from the environment enters the first end 130-1 of the fiber optic cable 130 and is reflected back through the fiber optic cable 130 to the optical detector of the TOF sensor 120.

In an embodiment of the TOF system with a single fiber optic cable, such as fiber optic cable 130, the system may further include a polarizer to polarize the emitted light, and/or filters to filter the reflected light, such that the emitted light and reflected light are “separated” within the fiber optic cable. Filtering the reflected light ensures that the detector does not detect extraneous light. Additionally, the detector may have a narrow wavelength sensitivity to match the wavelength of the emitted light.

In FIG. 1, the TOF system 100 is near an object 140. The solid arrow represents the distance between the end of the digit 110 and the object 140. If the TOF sensor were to be positioned at the distal end 111 of the digit 110, the distance between the digit 110 and the object 140 (herein the “physical distance”) would be too small for the TOF sensor to measure. The dashed arrow represents the distance, d, between the object 140 and the TOF sensor 120 (herein the “TOF path”). The distance, d, is the measurement used to calculate the proximity of an object. The distance, d, of the TOF path is equal to a length, L, of the fiber optic cable plus the physical distance. Extending the measurement distance of the TOF sensor to the TOF path using fiber optic cable 130 allows for measurement of the physical distance between the digit 110 and the object 140. The distance between the digit and object is d-L. The calculation for the TOF system 100 is (ct/2)-L, wherein c is the speed of light, and t is the time for the emitted light to reflect back to the detector. Due to the additional length provided by the fiber optic cable 130, the TOF system 100 can detect when the digit is touching an object, i.e., when d=L.

In a preferred embodiment, the TOF path is at least 10 mm, and therefore, the length, L, of the fiber optic cable is at least 10 mm.

FIGS. 1-4 represent alternative embodiments of the TOF system. In all embodiments the robot includes a control system comprising at least one processor and at least one memory which are configured to receive and process sensor data and to actuate the robot, including actuating the end effector (e.g., digit 110). The TOF sensor is communicatively connected to the control system. Processing of raw TOF sensor data may occur at a processor of the TOF sensor or may occur at a processor which is remote from the TOF sensor, such as at the at least one processor of the robot control system.

In FIGS. 1-4 the fiber optic cables are shown within the digit, however, in other embodiments, the fiber optic cables may be external to the digit (or similar end effector).

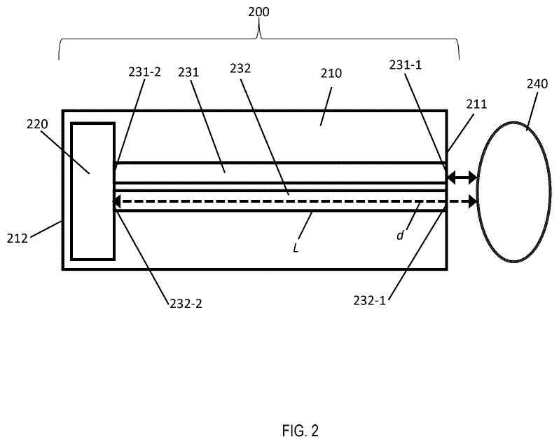

FIG. 2 is a block diagram of a robot end effector time-of-flight (TOF) system 200 with multiple fiber optic cables, according to an embodiment.

The TOF system 200 comprises a digit 210, a TOF sensor 220, and fiber optic cables 231 and 232. The TOF system 200 is part of a robot which exists within an environment.

The digit 210 and the TOF sensor 220 are similar or identical to digit 110 and TOF sensor 120 of FIG. 1.

Digit 210 has a distal end 211 and a proximal end 212, defined relative to an arm of the robot (not shown) to which the digit 210 is connected.

In FIG. 2, the TOF sensor 220 is located within the digit 210, however in other embodiments (see FIG. 4 below) the TOF sensor may be positioned externally to the digit while still being operably connected to the digit and the fiber optic cable.

The TOF sensor 220 includes at least one optical source configured to emit a light signal into fiber optic cable 231 and at least one optical detector configured to receive a reflected light signal back from fiber optic cable 232.

A first end 232-1 of the fiber optic cable 231 is positioned at the distal end 211 of the digit 210 and a second end 231-2 of the fiber optic cable 231 is positioned at the TOF sensor 220. A first end 232-1 of the fiber optic cable 232 is positioned at the distal end 211 of the digit 210 and a second end 232-2 of the fiber optic cable 232 is positioned at the TOF sensor 220. Light from the optical source is emitted out of the first end 231-1 of the first fiber optic cable 231 into the environment of the robot. Light reflected back from the environment enters the first end 232-1 of the second fiber optic cable 232 and is reflected back through the second fiber optic cable 232 to the optical detector of the TOF sensor 220.

Because emitting light and receiving light are performed by two different fiber optic cables, polarization and filtering of the light is not required to separate emitting and reflected light in TOF system 200.

In FIG. 2, the TOF system 200 is near an object 240. The solid arrow represents the physical distance between the end of the digit 210 and the object 240, which is too short for a TOF sensor to measure. The dashed arrow represents the distance, d, between the object 240 and the TOF sensor 220 (herein the “TOF path”). The distance, d, is the measurement used to calculate the proximity of an object. The distance, d, of the TOF path is equal to a length, L, of the fiber optic cable plus the physical distance. Extending the measurement distance of the TOF sensor to the TOF path using fiber optic cable 232 allows for measurement of the physical distance between the digit 210 and the object 240. The distance between the digit and object is d-L. The calculation for the TOF system 200 is (ct/2)-L, wherein c is the speed of light, and t is the time for the emitted light to reflect back to the detector. Due to the additional length provided by the fiber optic cables 231 and 232, the TOF system 200 can detect when the digit is touching an object, i.e., when d=L.

In FIGS. 1 and 2, a single fiber optic cable and a pair of fiber optic cables are shown. However, in other embodiments any number of fiber optic cables may be used to measure the distance between the digit and an object.

In some embodiments, a single fiber optic cable may emit light, with multiple fiber optic cables receiving reflected light.

In some embodiments, the TOF sensor may have an n×n grid (where n is any integer) of detection zones wherein each zone receives reflected light from a respective set of fiber optic cables (wherein a set includes at least one fiber optic cable).

In FIGS. 1 and 2, the distal end of the digit is “uncovered”. That is, the fiber optic cable is exposed to the external environment of the digit. This embodiment allows for detecting distances of objects relative to the distal end of the digit, for example distances to approaching objects, where the distance reduces as the object approaches (or is approached), as well as detecting when the digit it touching an object (i.e., d=L). This embodiment may also allow for the texture of an object to be detected when the properties of the surface of the object are optically recognizable.

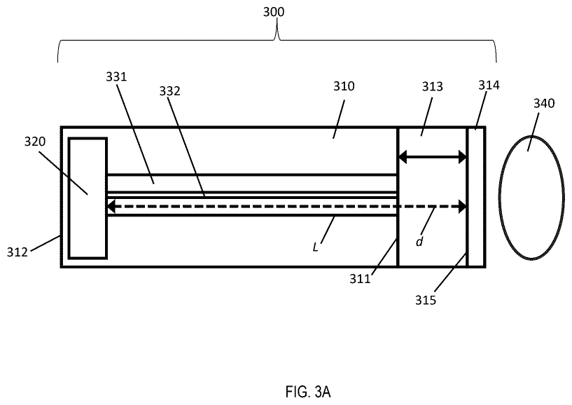

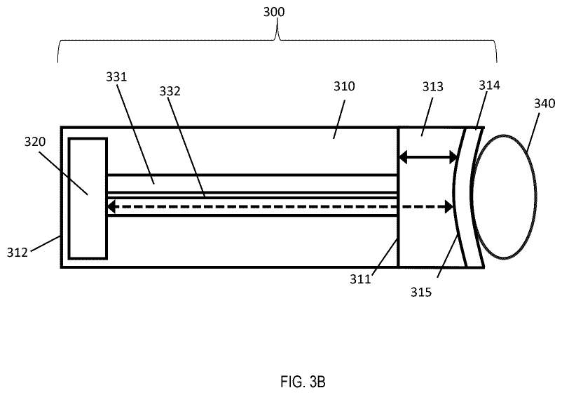

FIGS. 3A and 3B are block diagrams which show an embodiment where a digit 310 of a robot end effector time-of-flight (TOF) system 300 includes a distal internal volume 313 with a compliant covering 314, according to an embodiment.

In FIG. 3A the digit is not touching an object 340, while in FIG. 3B the digit is touching the object 340.

In both FIGS. 3A and 3B, the TOF system 300 comprises digit 310, a TOF sensor 320, and fiber optic cables 331 and 332. The TOF system 300 is part of a robot which exists within an environment.

The TOF sensor 320 is similar or identical to TOF sensor 120 of FIG. 1 and TOF sensor 220 of FIG. 2. The fiber optic cables 331 and 331 are similar or identical to fiber optic cables 231 and 232 of FIG. 2.

As in FIG. 2, the TOF sensor 320 includes at least one optical source configured to emit a light signal into fiber optic cable 331 and at least one optical detector configured to receive a reflected light signal back from fiber optic cable 332.

Digit 310 has a distal end 311 and a proximal end 312, defined relative to an arm of the robot (not shown) to which the digit 310 is connected. An internal volume 313 with a compliant covering 314 is located at the distal end 311 of digit 310. The internal volume 313 may be filled with a gas (or other compressible material), similar to an inflated balloon wherein the compliant covering 314 is similar to the balloon and the internal volume 313 is similar to an interior of the balloon. Of note, while a balloon generally has internal pressure greater than an external pressure, the internal volume 313 may have an internal pressure which is equal to the external pressure, or may have an internal pressure greater than the external pressure.

When an object, for example object 340, touches and applies force to the compliant covering 314 of the internal volume 313, the internal volume is deformed. The TOF sensor 320 measures the distance from the distal end 311 of the digit 310 to an interior surface 315 of the internal volume 313, wherein said distance changes when the compliant covering is deformed. That is, the TOF sensor 320 senses the interior surface 315 of the internal volume 313 at the distal end of the digit 310 and is configured to detect changes in the profile of said interior surface 315.

The solid arrow represents the physical distance between the distal end 311 of the digit 310 and the interior surface 315 of internal volume 313, which is too short for a conventional TOF sensor to measure. When the compliant covering is not touching an object, the physical distance between the distal end 311 and the internal surface 315 is at a maximum distance. When an object touches the compliant covering and deforms the internal surface 315, the physical distance becomes shorter. The dashed arrow represents a distance, d, of the TOF path between the interior surface 315 of the internal volume 313 and the TOF sensor 320, which is a measurable distance for the TOF sensor 320. The distance, d, is the measurement used to calculate the proximity of an object. The distance, d, of the TOF path is equal to a length, L, of the fiber optic cable plus the physical distance between the distal end 311 and the internal surface 315. The calculation for the TOF system 100 is (ct/2)-L, wherein c is the speed of light, and t is the time for the emitted light to reflect back to the detector. Due to the additional length provided by the fiber optic cables 331 and 332, the TOF system 300 can detect when the digit is touching an object, i.e., when d<(L+the maximum physical distance between the distal end 311 and the internal surface 315).

FIG. 3A shows that object 340 is not touching the compliant covering 314.

FIG. 3B shows object 340 touching the compliant covering 314 and applying a force such that the interior surface 315 of internal volume 313 is deformed and is closer to the distal end 311 of digit 310. Therefore, in FIG. 3B, the distance that light travels to reflect off of the interior surface 315 and back to the TOF sensor 320 through fiber optic cable 332 is reduced (compared to FIG. 3A), allowing the robot to sense that an object is being touched (as well as the amount of pressure that is being applied at the digit). This embodiment allows for dexterous manipulation by the robot, whereby digits have the ability to grip an object and to be compliant to a surface being touched.

In FIG. 3A and B, only a single internal volume is shown, however in other embodiments there may be multiple internal volumes at the distal end of the digit. Each internal volume may have a respective set of fiber optic cables, wherein a set includes at least one fiber optic cable. In some embodiments, there may be a single compliant covering with a single congruent surface which covers all of the multiple internal volumes wherein the structure of the tip of the digit resembles a honeycomb with each cell having a respective set of fiber optic cables (wherein a set is at least one fiber optic cable). As in FIG. 1, a single fiber optic cable may be used for each internal volume wherein light is emitted and reflected in the same fiber optic cable, or as in FIGS. 2 and 3 multiple fiber optic cables may be used for each internal volume with different fiber optic cables dedicated to emission and reflection.

FIG. 4A is a block diagram of a robot end effector TOF system 400a including a digit 410 with multiple internal volumes 413-1, 413-2, 413-3, and 413-4 (collectively referred to as 413) covered by a single compliant covering.

Digit 410a has a distal end 411 and a proximal end 412, defined relative to an arm of the robot (not shown) to which the digit 410a is connected. Internal volumes 413 are located at the distal end 411 of digit 410a and are covered by a single compliant covering 414.

Each internal volume 413 has a respective fiber optic cable 431 (individually referred to as 431-1, 431-2, 431-3, and 431-4) which is connected to a TOF sensor 420.

As in FIGS. 2, 3A, and 3B, the TOF sensor 420 includes at least one optical source configured to emit a light signal into fiber optic cables 431-1, 431-2, 431-3, and 431-4 and at least one optical detector configured to receive a reflected light signal back from fiber optic cables 431-1, 431-2, 431-3, and 431-4.

In other embodiments, as described above, each internal volume may have more than one fiber optic cable.

Each internal volume 413 has an internal surface 415 (only one labelled to reduce clutter) wherein, as above, the distance the light travels from and to the TOF sensor 420 includes the length, L, of the fiber optic cables and the distance between the distal end 411 and a given internal surface 415, wherein when an object touches the compliant covering 414, at least one of the internal volumes 413 is deformed such that the distance between the distal end 311 and at least one internal surface 415 is decreased.

FIG. 4B is a block diagram of a robot end effector TOF system 400b which is similar to robot end effector 400a of FIG. 4A but includes a respective compliant covering 414 (only one labelled to reduce clutter) for each internal volume 413-1, 413-2, 413-3, and 413-4 (collectively referred to as 413). Digit 410b has a distal end 411 and a proximal end 412, defined relative to an arm of the robot (not shown) to which the digit 410b is connected. Internal volumes 413 are located at the distal end 411 of digit 410a and are each covered by a respective compliant covering 414.

Each internal volume 413 has a respective fiber optic cable 431 (individually referred to as 431-1, 431-2, 431-3, and 431-4) which is connected to a TOF sensor 420.

The TOF sensor 420 includes at least one optical source configured to emit a light signal into fiber optic cables 431-1, 431-2, 431-3, and 431-4 and at least one optical detector configured to receive a reflected light signal back from fiber optic cables 431-1, 431-2, 431-3, and 431-4.

Each internal volume 413 has an internal surface 415 (only one labelled to reduce clutter) wherein, as above, the distance the light travels from and to the TOF sensor 420 includes the length, L, of the fiber optic cables and the distance between the distal end 411 and a given internal surface 415, wherein when an object touches a specific compliant covering 414 the respective internal volume 413 is deformed such that the distance between the distal end 311 and the respective internal surface 415 is decreased.

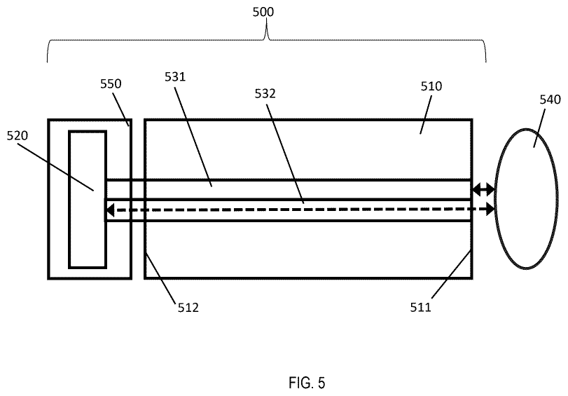

FIG. 5 is a block diagram of a robot end effector time-of-flight (TOF) system 500 wherein a TOF sensor 520 is external to the end effector, according to an embodiment.

The system of FIG. 5 is similar to the system of FIG. 2 and includes a digit 510 having a distal end 511 and a proximal end 512, a TOF sensor 520, and a pair of fiber optic cables 531 and 532. FIG. 5 differs from FIG. 2 as the TOF sensor 520 is not located within the digit 510 but is located within palm 550 of the robot, wherein the end effector is a humanoid hand comprising at least one digit and a palm.

In FIG. 5, the TOF system 500 is near an object 540. The solid arrow represents the physical distance between the end of the digit 510 and the object 540, which is too short for a conventional TOF sensor to measure. The dashed arrow represents a distance, d, of the TOF path between the object 540 and the TOF sensor 520 which is a measurable distance for the TOF sensor 520 and is longer than the length of the digit 510. The distance, d, is the measurement used to calculate the proximity of an object. The distance, d, of the TOF path is equal to a length, L, of the fiber optic cable plus the physical distance. The distance between the digit and object is d-L. The calculation for the TOF system 500 is (ct/2)-L, wherein c is the speed of light, and t is the time for the emitted light to reflect back to the detector. Due to the additional length provided by the fiber optic cables 531 and 532, the TOF system 500 can detect when the digit is touching an object, i.e., when d=L.

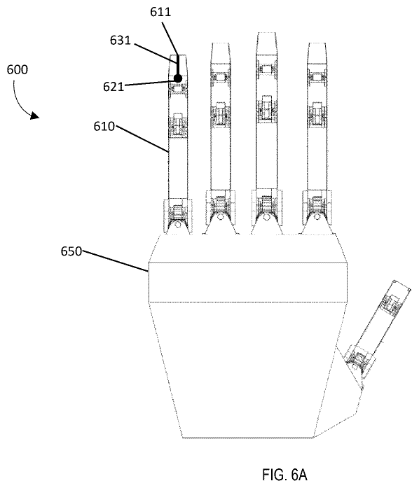

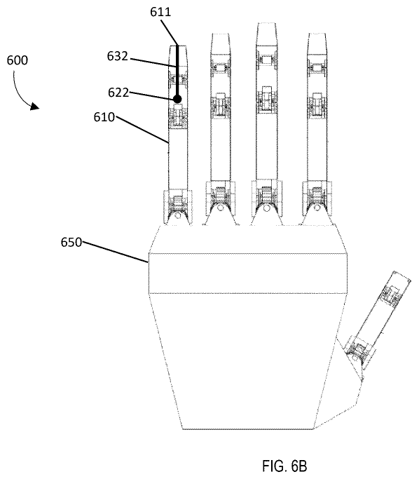

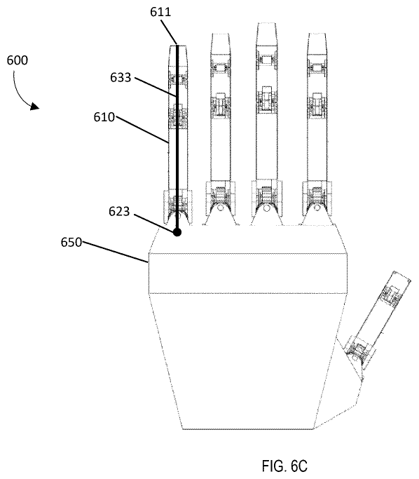

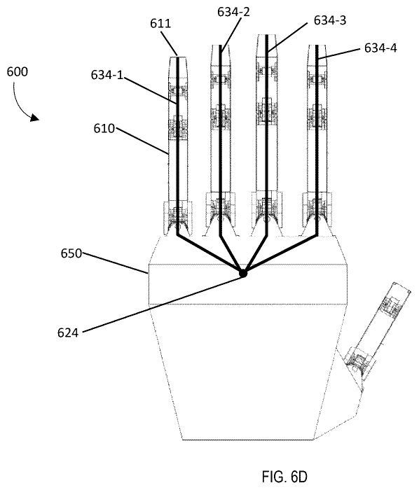

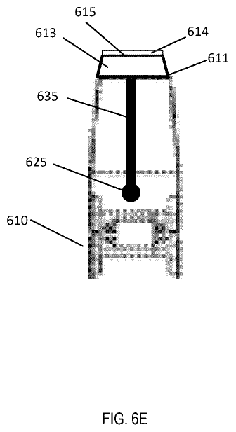

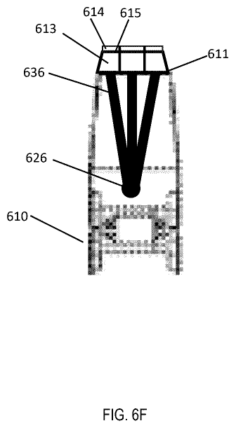

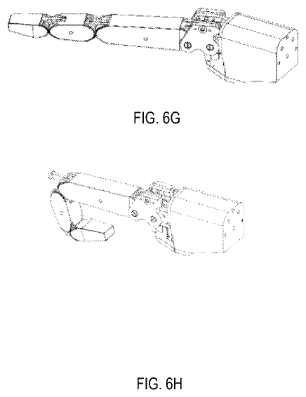

In FIGS. 1-5, the digit is shown as straight, however, an actuatable digit may have pivot points or otherwise be capable of bending to perform work. Therefore, any fiber optic cables which are located at pivot points must be capable of bending as well. FIGS. 6A-6H are examples of robotic hands and digits which may include a TOF sensor system.

FIGS. 6A-D show a schematic diagram of a robot end effector 600 resembling a human hand, according to various embodiments. FIG. 6G is a schematic diagram of a digit of the robot end effector 600 in an extended position and FIG. 6H is a schematic diagram of the digit in a bent position.

The end effector 600 includes digit 610 as well as three other digits resembling non-thumb fingers and one digit in the location of a thumb. The digits are connected to a palm 650. Each digit has a distal end. Digit 610 and the other three digits resembling fingers have three joints (i.e., pivot points) where the digit can bend, while the thumb digit only as two joints, mimicking the joints of human fingers.

FIG. 6G shows digit 610 in an extended position where none of the joints are bent. FIG. 6H shows digit 610 in a bent position wherein the two most distal joints are bent.

FIGS. 6A-D show four different locations at which a TOF sensor could be located. The locations are examples and are not meant to be exhaustive. FIGS. 6A-6C only show a TOF sensor system in a single digit, however, it is to be understood that a similar or different TOF sensor system may also be present in each of the other digits of the end effector 600.

In FIG. 6A, a TOF sensor 621 is at a first location within the most distal section of the digit 610. In this location the set of fiber optic cables 631 (shown as a single solid black line, but may include more than one cable) which form a path for light emission from digit 610 and for light reflection back to the TOF sensor do not cross a joint of the digit 610.

In FIG. 6B, a TOF sensor 622 is at a second location within the second most distal section of the digit 610. In this location the set of fiber optic cables 632 (shown as a solid black line, but may include more than one cable) which form a path for light emission from digit 610 and for light reflection back to the TOF sensor cross a single joint. Therefore, the set of fiber optic cables must be bendable.

In FIG. 6C, a TOF sensor 623 is at a third location within the palm 650. In this location the set of fiber optic cables 633 (shown as a solid black line, but may include more than one cable) which form a path for light emission from digit 610 and for light reflection back to the TOF sensor cross all three joints. Therefore, the set of fiber optic cables must be bendable.

In FIG. 6D, a TOF sensor 624 is at a fourth location within the palm, as in FIG. 5C, but further away from the distal end of the digits. In this location, the single TOF sensor is connected to multiple sets of fiber optic cables 634-1, 634-2, 634-3, and 634-4, with each set forming a path for light emission to and light reflection from one of the multiple non-thumb digits of robot end effector 600 (only digit 610 is labelled to reduce clutter). Each set of fiber optic cables crosses multiple joints, with non-thumb digits having three joints. Therefore, each set of fiber optic cables must be bendable.

In FIG. 6E, a close up of the tip of digit 610 is shown, wherein the tip has an internal volume 613 and a compliant covering 614. A TOF sensor 625 is located at the same location as in FIG. 6A. A set of fiber optic cables 635 (represented by a single solid black line, but may include more than one cable) runs from the TOF sensor 625 to a distal end 611 of digit 610. Light emitted from TOF sensor 625 reflects back to the TOF sensor off of an internal surface 615 of the internal volume 613 through at least one cable of the set of fiber optic cables 635, wherein the internal surface 615 will be closer to the TOF sensor 625 when the compliant covering 614 is deformed due to touching of an object.

In FIG. 6F, a close up of the tip of digit 610 is shown, wherein the tip has multiple internal volumes 613 (only one labelled to reduce clutter) and each internal volume has a respective compliant covering 614 (only one labelled to reduce clutter). A TOF sensor 626 is located at the same location as in FIG. 6A and FIG. 6E. Multiple sets of fiber optic cables 636 (only one labelled to reduce clutter) (represented by single solid black lines, but may include more than one cable) run from the TOF sensor 626 to a distal end 611 of digit 610, with a respective set of fiber optic cables for each internal volume 613. Light emitted from TOF sensor 626 reflects back to the TOF sensor off of a respective internal surface 615 (only one labelled to reduce clutter) of each internal volume 613 through the respective set of fiber optic cables 636, wherein a given internal surface 615 will be closer to the TOF sensor 626 when a respective compliant covering 614 is deformed due to touching of an object.

The control system of the robot may receive positional data regarding the extended or bent state of the digit to properly calculate the distance of the digit to an object or to perform touch sensing for the digit, as bending the fiber optic cables may affect the internal reflection of light.

As shown in FIG. 6-DA, an end effector may include multiple digits. In some embodiments, each digit may have a respective and separate TOF sensor system. In some embodiments, each digit may have a respective set of fiber optic cables but may share a TOF sensor.

As described above, the set of fiber optic cables for each digit may comprise a single-channel system wherein a single fiber optic cable is responsible for both transmitting emitted light and transmitting reflected light, or the set of fiber optic cables may comprise a multi-channel system including a pair of fiber optic cables with a first cable dedicated to light emission and a second cable dedicated to transmitting reflected light, or more than two fiber optic cables wherein a first subset of fiber optic cables are dedicated to light emission and a second subset of fiber optic cables are dedicated to transmitting reflected light. The first subset of fiber optic cables may include a single cable.

In some embodiments the TOF sensor includes a single optical detector. In some embodiments, the TOF sensor includes a respective optical detector or optical detector region for each fiber optic cable dedicated to receiving reflected light.

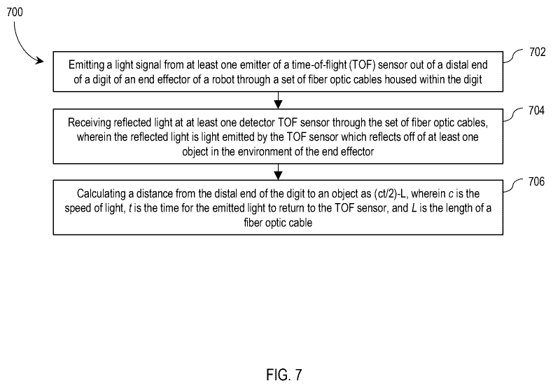

FIG. 7 is a flow diagram of a method of calculating a distance to an object using a TOF system, according to an embodiment.

The TOF system may be similar to any of the TOF systems described above (e.g., TOF systems 100, 200, 300, 400 or 500). The TOF system includes a TOF sensor housed within an end effector of a robot, wherein the end effector includes at least one digit. The digit houses a set of fiber optic cables, wherein the set includes at least one fiber optic cable, and wherein a first end of each fiber optic cable is coupled to the TOF sensor and a second end of each fiber optic cable is at a distal end of the digit.

At 702, at least one emitter of the TOF sensor emits a light signal out of the distal end of the digit through at least one fiber optic cable of the set of fiber optic cables. The light signal may be a pulse. The light signal may comprises a narrow wavelength band.

The TOF sensor may include multiple emitters and the multiple emitters may emit light of different wavelengths.

In an embodiment, the set of fiber optic cables may include a single fiber optic cable which both emits and receives light. In another embodiment, the set of fiber optic cables may include a single fiber optic cable for emitting light and multiple fiber optic cables for receiving light. In another embodiment, the set of fiber optic cables may include multiple fiber optic cables for emitting light and multiple fiber optic cables for receiving light.

At 704, at least one detector of the TOF sensor receives reflected light through the set of fiber optic cables. The reflected light is emitted light which has reflected off of at least one object in the environment of the digit.

As above, in an embodiment, the set of fiber optic cables may include a single fiber optic cable which both emits and receives light. In another embodiment, the set of fiber optic cables may include a single fiber optic cable for emitting light and multiple fiber optic cables for receiving light. In another embodiment, the set of fiber optic cables may include multiple fiber optic cables for emitting light and multiple fiber optic cables for receiving light.

In an embodiment, each fiber optic cable which receives and transmits reflected light may transmit the light to one single detector. In another embodiment, each fiber optic cable which receives and transmits reflected light may transmit the light to a respective detector. In another embodiments, subsets of fiber optic cables which receive and transmit reflected light may transmit the light to the same detector.

At 706, a distance from the distal end of the digit to an object is calculated as (ct/2)-L, wherein c is the speed of light, t is the time lapsed for the emitted light signal to return to the TOF sensor, and L is the length of a fiber optic cable.

As above, there are various possible configurations for the set of fiber optic cables. When the set of fiber optic cables is a single fiber optic cable which both emits and receives light, L is the length of fiber optic cable. However, for other configuration L must be determined by dividing the sum of the length of the emitting fiber optic cable, or L_{E}, and the length of the receiving fiber optic cable, or L_{R}, by two. That is, unless all fiber optic cables have the exact same length (and have not been bent) the value of L must be determined for each set of emitting and receiving fiber optic cables which provided reflected light to a detector. Alternatively, when the emitting and receiving fiber optic cables are not the same cable or are not the same length, the distance may be calculated as ct-(L_{E}+L_{R}).

The claims of the disclosure are below. This disclosure is intended to support, enable, and illustrate the claims but is not intended to limit the scope of the claims to any specific implementations or embodiments. In general, the claims should be construed to include all possible implementations and embodiments along with the full scope of equivalents to which such claims are entitled.

1. A robot end effector comprising:
a digit;
a tactile sensor system coupled to the digit, the tactile sensor system comprising:
a set of fiber optic cables carried by the digit, the set of fiber optic cables including at least one fiber optic cable, wherein each fiber optic cable has a respective length and wherein a first end of each fiber optic cable is at a distal end of the digit; and
a time-of-flight (TOF) sensor coupled to a second end of each fiber optic cable, wherein the TOF sensor emits light through at least a first subset of the set of fiber optic cables, and receives light reflected by at least one object at or proximate the distal end of the digit through at least a second subset of the set of fiber optic cables, wherein a distance to the at least one object is calculable from a TOF path including a length of fiber optic cable.

2. The robot end effector of claim 1 wherein the TOF sensor includes a single optical source.

3. The robot end effector of claim 2 wherein the TOF sensor includes a single optical detector.

4. The robot end effector of claim 2 wherein the TOF sensor includes a plurality of optical detectors.

5. The robot end effector of claim 4 wherein each optical detector of the plurality of optical detectors is coupled to a respective fiber optic cable of the second subset of the set of fiber optic cables.

6. The robot end effector of claim 1 wherein the set of fiber optic cables consists of a single fiber optic cable, wherein the first subset of fiber optic cables and the second subset of fibre optic cables are both the single fiber optic cable.

7. The robot end effector of claim 1 wherein the first subset of the set of fiber optic cables consists of a first fiber optic cable which transmits emitted light from the TOF sensor and the second subset of the set of fiber optic cables consists of a second fiber optic cable which transmits reflected light back to the TOF sensor.

8. The robot end effector of claim 1 wherein the first subset of the set of fiber optic cables includes a plurality of fiber optic cables which transmit emitted light from the TOF sensor and the second subset of the set of fiber optic cables includes a plurality of fiber optic cables which transmit reflected light back to the TOF sensor.

9. The robot end effector of claim 1 wherein the first subset of the set of fiber optic cables includes only one fiber optic cable which transmits emitted light from the TOF sensor and the second subset of the set of fiber optic cables includes a plurality of fiber optic cables which transmit reflected light back to the TOF sensor.

10. The robot end effector of claim 1 wherein the at least one object is an object external to the end effector.

11. The robot end effector of claim 1 wherein the at least one object is a compliant covering on the digit, wherein the light is reflected from an inner surface of the compliant covering, and wherein the inner surface of the compliant covering is depressed when the digit touches an external object.

12. The robot end effector of claim 11 wherein the compliant covering comprises a plurality of internal volumes wherein at least one fiber optic cable of the set of fiber optic cables is directed into each respective internal volume of the plurality of internal volumes.

13. The robot end effector of claim 1 comprising a second digit with a second tactile sensor system coupled to the second digit.

14. The robot end effector of claim 1 comprising at least a second digit wherein the tactile sensor system is coupled to the at least a second digit, wherein the tactile sensor system further comprises at least a second set of fiber optic cables, wherein each additional digit is coupled to a respective set of fiber optic cables of the at least a second set of fiber optic cables.

15. The robot end effector of claim 1 wherein the digit is actuatable around at least one pivot point, wherein the set of fiber optic cables pass through the at least one pivot point and accommodate bending at the at least one pivot point.

16. A method of calculating a distance of a robot end effector to an object using a time-of-flight (TOF) system, the method comprising:
emitting a light signal from at least one emitter of a time-of-flight (TOF) sensor, wherein the light signal passes out of a distal end of a digit of the robot end effector through a set of fiber optic cables housed within the digit;
receiving reflected light by at least one detector of the TOF sensor through the set of fiber optic cables, wherein the reflected light is light from the light signal which reflects off of an object; and
calculating a distance from the distal end of the digit to the object as related to a length of fiber optic cable.

17. The method of claim 16, wherein the set of fiber optic cables includes multiple fiber optic cables for emitting light and multiple fiber optic cables for receiving light.

18. The method of claim 16, wherein the at least one object is an object external to the end effector.

19. The method of claim 16, wherein the at least one object is a compliant covering on the digit, wherein the light is reflected from an inner surface of the compliant covering, and wherein the inner surface of the compliant covering is depressed when the digit touches an external object.

20. The method of claim 16 wherein calculating the distance from the distal end of the digit to the object as related to the length of fiber optic cable includes calculating the distance from the distal end of the digit to the object as related to (ct/2)-L, wherein c is a speed of light, t is a time for the emitted light to return to the TOF sensor, and L is the length of fiber optic cable.
